(19) United States
(12) Patent Application Publication
(10) Pub. No.: US 2011/0148073 A1
(43) Pub. Date: Jun. 23, 2011

(54) Rear Outrigger for Wrecker

(76) Inventor: David How-Hwa Hwang, Seattle, WA (US)

(21) Appl. No.: 12/766,695

(22) Filed: Apr. 23, 2010

(30) Foreign Application Priority Data
Dec. 22, 2009 (CN) 200920290911.7

(51) Int. Cl. B60S 9/02; B66C 23/78

(52) U.S. Cl. 280/415.1; 280/766.1

(57) ABSTRACT

A device relocates an underlift/vertical arm assembly from the end of a sub-frame to the boom of a wrecker, and hence whole space of the end of sub-frame is used to design rear outriggers that will certainly exhibit an excellent performance. An advantage of a large space for this specific application is to design a wider span of rear outriggers, as completely extended, to match that of the front outriggers, and in the mean time, the tip of a rear outrigger has a sufficient strength to maintain a good stability. The increased length of overlapping part in each section of the three stage outriggers assists to achieve this goal. As the three stage outriggers are fully extended, the tip of each right/left side is additionally reinforced by a diagonal folding bar which bridges between an outer vertical barrel and the end of primary inner sleeve. Consequently, a combination of wider spans and higher stiffnesses at the tip of the rear outrigger provides the wrecker with a superior stability. Besides, the sophisticated rear outriggers are easier to operate because it may be a single hydraulic control system. The combined results give the best rear outriggers in the towing industry.

### BACKGROUND OF THE INVENTION

1. Field of the Invention

The present invention is related to rear outriggers used for a wrecker. The rear right/left outriggers are designed to increase both span and stiffness by using whole space of the end of sub-frame as an underlift/vertical arm assembly is relocated from the end of sub-frame to the boom of the wrecker.

2. Description of the Related Art

The rear support device used for traditional street wreckers, derrick cars, or elevating platform vehicles, etc., basically adopt a structure with two separated independent outriggers, and thereat such structure has been used for decades without any significant change. Due to the presence of an underlift between the right/left rear outriggers, the extended span of rear outriggers is usually much shorter than that of front outriggers. This leads to the decrease of stability of a wrecker while lifting a heavy object. In order to surmount this disadvantage, the three stage rear outriggers were designed to match the span of front outriggers. However, stiffness at the tip of each rear outrigger may be a concern as it is completely extended.

Another rear outrigger is a kind of under-frame structure, but locates in front of the last two rear wheels. This results in a short distance between front and rear outriggers and that brings attention to the stability situation while the wrecker is lifting a heavy wrecked object.

### SUMMARY OF THE INVENTION

The present invention, therefore, provides a new design of rear outriggers to overcome the problems described above. A key idea of the present invention is to relocate an underlift/vertical arm assembly from the end of sub-frame to the boom of a wrecker, and hence whole space of the end of sub-frame is used to design rear outriggers that will certainly exhibit an excellent performance. An advantage of a large space for this specific application is to design a wider span of rear outriggers, as completely extended, to match that of the front outriggers, and in the mean time, the tip of rear outrigger has a sufficient strength to maintain a good stability. In the present invention, the increased length of overlapping part in each section of the three stage outriggers assists to achieve this goal. As the three stage outriggers are fully extended, the tip of each right/left side is additionally reinforced by a diagonal folding bar which bridges between an outer vertical barrel and the end of primary inner sleeve. Consequently, a combination of wider span and higher stiffness at the tip of rear outrigger provides the wrecker with a superior stability. Besides, the sophisticated rear outriggers are easier to operate because it is a single hydraulic control system. The combined all results give the invented rear outriggers the best in the towing industry.

In order to achieve the above-mentioned goals, the present invention, therefore, adopts the advanced technology solutions described as follows:

It primarily comprises an outer horizontal barrel along with two rear inner vertical barrels that are symmetrically fastened on the outer horizontal barrel, wherein, two outer vertical barrels are fixed onto the subframe and also integrated all together via a horizontal bar, and in addition, two inner vertical barrels are connected to the two outer vertical barrels, respectively via hydraulic cylinder-I and hinge pin-I. Furthermore, primary inner sleeve and secondary inner sleeve are equipped internally at each end of an outer horizontal barrel, and additionally, the primary inner sleeve and secondary inner sleeve are interlinked with the hinge pin-II via the hydraulic cylinder-II inside the outer horizontal barrel. Besides, a diagonal lever-I is symmetrically fixed to a position between the top end of two inner vertical barrels and an outer horizontal barrel, and moreover, a diagonal lever-II is symmetrically fixed to a position between the top end of two outer vertical barrels and two primary inner sleeves.

Two steel rings are installed at each external wall of two outer vertical barrels respectively, and one end of the diagonal lever-II is connected with a steel ring and the other end of diagonal lever-II is then linked to the external wall of primary inner sleeve via hinge pin-III thereof.

The present invention typically changes the rear outrigger structure in terms of both extensible left/right outriggers, in which, both rear inner vertical barrel and outer horizontal barrel are fastened and integrated into a rear support bracket. Therefore, both primary inner sleeve and secondary inner sleeve installed inside the outer horizontal barrel will be extended approximate 400 cm (158″) in each side, and in this way, both right/left outriggers are extendible to a span (two outer small circles in FIG. 4) similar to the front outriggers. In this fully extended condition, the right/left diagonal level I and II do strengthen its structural rigidity. The relevant operational functions in terms of the lifting function of rear inner vertical barrel and also the extensible/retractable functions of outer horizontal barrel as well as primary inner sleeves and secondary inner sleeves will be activated by each internal hydraulic cylinder respectively, so that it will be able to provide relevant operators with a comfortable working circumstance and meanwhile improving relevant equipment's operational effectiveness accordingly.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a rear structural schematic view showing the operating status of the present invention;

FIG. 2 is a rear structural schematic view showing the idle status of the present invention;

FIG. 3 is a schematic view showing the installation position in accordance with the present invention;

FIG. 4 is a top schematic view showing the operating status of the present invention;

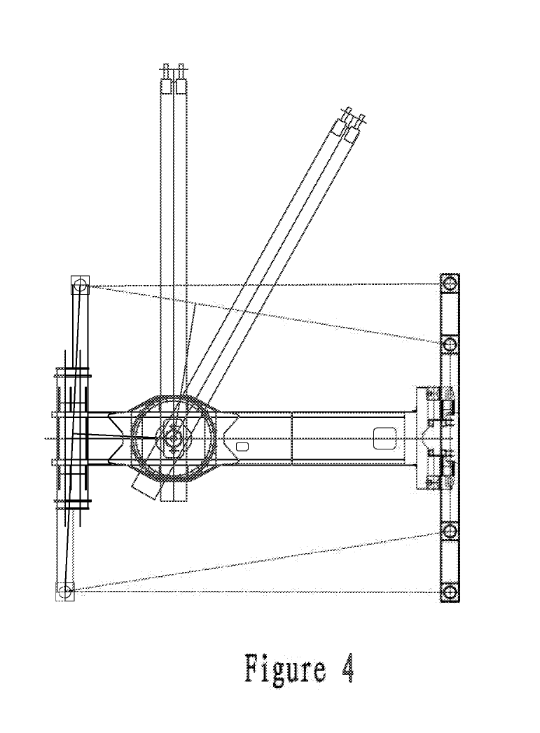

FIG. 5 is a perspective drawing view showing a strong supporting structure for the underlift/vertical arm assembly;

FIG. 6 is a schematic view showing the front supporting structure;

FIG. 7 is a schematic view the street wrecker towing wrecked object during the period of transportation.

### DETAILED DESCRIPTION OF THE PREFERRED EMBODIMENT

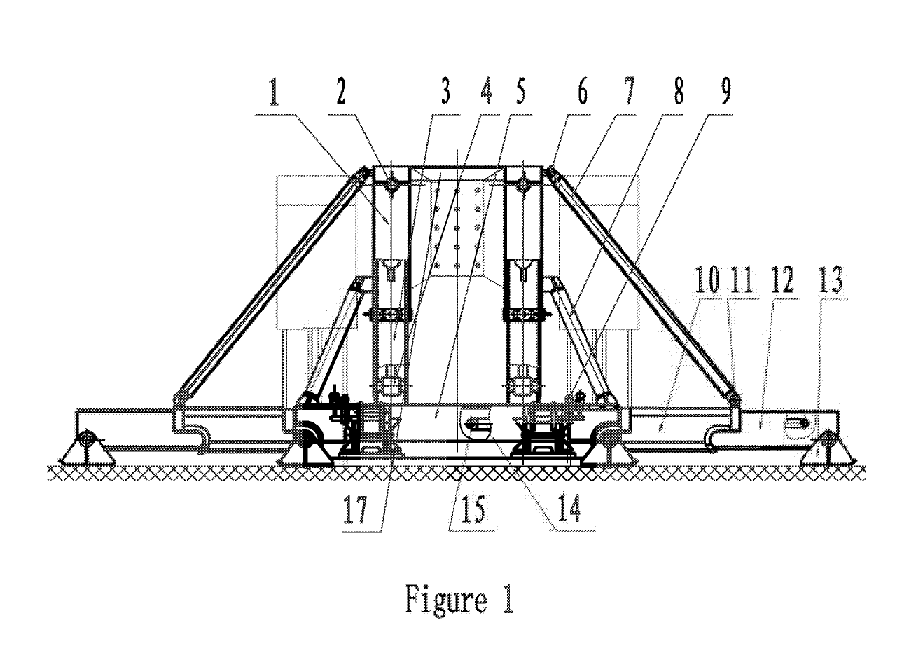

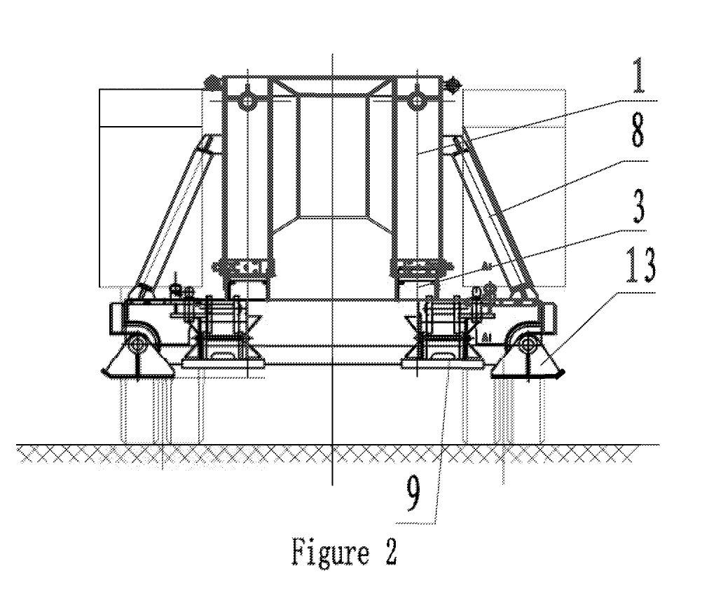

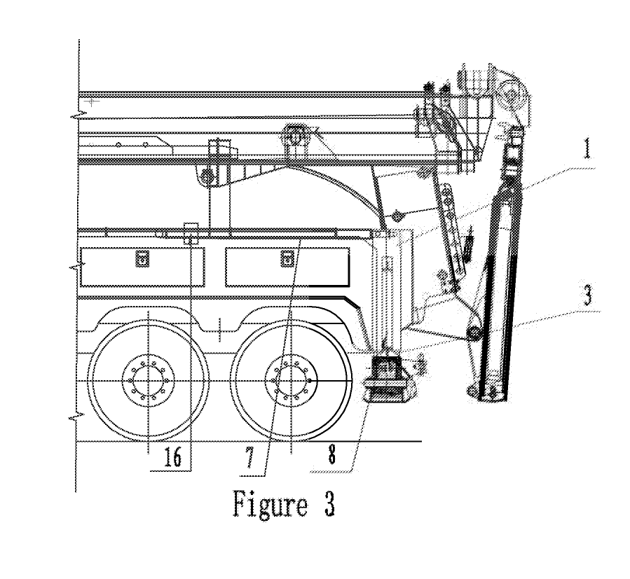

With reference to FIGS. 1, 2 and 3, it is shown that two rear inner vertical barrels 3 are symmetrically fastened on the outer horizontal barrel 5 to construct a one-piece fixed structure, and thereat, two rear inner vertical barrels 3 are connected with two outer vertical barrels 1 via the hydraulic cylinder-I 4 and hinge pin-I 2, and furthermore two outer vertical barrels are welded together with a horizontal bar 17. Primary inner sleeve 10 and secondary inner sleeve 12 are internally equipped at each end of an outer horizontal barrel 5 and additionally, the primary inner sleeve 10 and secondary inner sleeve 12 are interlinked with the hinge pin-II 15 via the hydraulic cylinder-II 14 inside an outer horizontal barrel 5. A diagonal lever-I 8 having a structure of hollow steel pillar is symmetrically fixed to a position between the top end of two rear inner vertical barrels 3 and an outer horizontal barrel 5. Moreover, two steel rings 6 are equipped at external walls of the outer vertical barrel 1 and both steel rings 6 are linked to one end of the diagonal lever-II 7, and the primary inner sleeve 10 is linked to the other end of diagonal lever-II 7 via hinge pin-III 11. The supporting function provided by the right/left diagonal lever-I 8 and -II 7 will greatly strengthen rigidity of the rear outriggers. Two outrigger pads-I 9 are installed at each end of an outer horizontal barrel 5. Other two outrigger pads-II 13 are also installed at the rear end of two secondary inner sleeves 12 so as to enhance its traction, the supporting capacity and the friction with the ground as well.

While the mission-specific vehicle arrives at the working site, the rear outriggers consisting of two rear inner vertical barrels 3 and an outer horizontal barrel 5 will be dropped down and stopped at about an altitude of 10 cm (4″) above the ground by hydraulic cylinder-I 4 inside the outer vertical barrel 1, and at this moment, both primary inner sleeve 10 and secondary inner sleeve 12 installed inside an outer horizontal barrel 5 will be pushed by the hydraulic cylinder-I 4 as well and extending maximally along left/right direction away from the outer horizontal barrel 5, and then, rear outriggers will be dropped down to the ground continuously, but they will completely stop when both outrigger pads-I 9 and outrigger pads-II 13 have touched ground completely. During the period of idle status, one end of the diagonal lever-II 7 will be coupled with a steel ring 6 and the other end of diagonal lever-II 7 will be laid on the claw 16 of the vehicle. Prior to the actual operation, it is necessary to pick up the diagonal lever-II 7 from the claw 16 and then inserting it into an outer pin hole on the primary inner sleeve 10 with the hinge pin-III 11, and operations in reverse order shall be conducted upon the idle condition.

In light of the above facts, the rear outrigger device, which is used for a street wrecker, derrick car, or elevating platform vehicle etc., provided according to the present invention will be able to increase the strength of rear outriggers, enlarge the supporting distance, and extend the overall supporting area for the mission specific vehicles, such as a street wrecker by greatly enhancing its stability during the period of lifting operation.

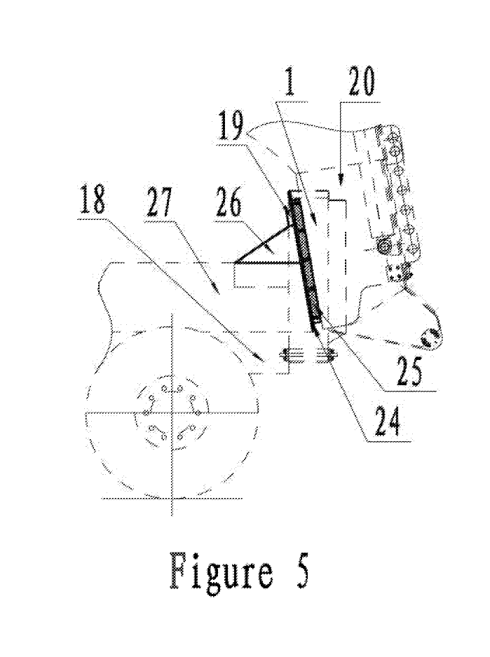

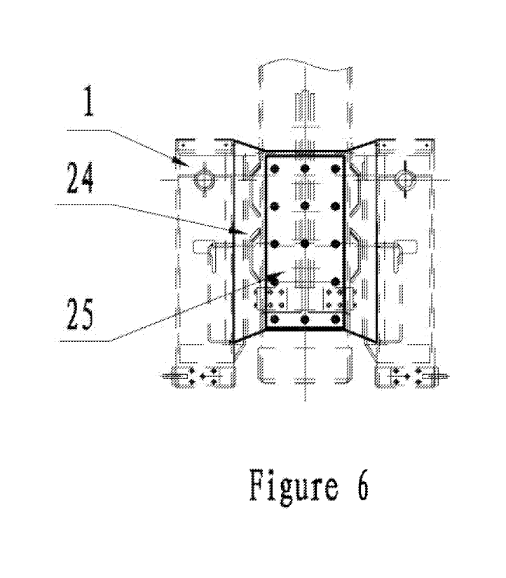

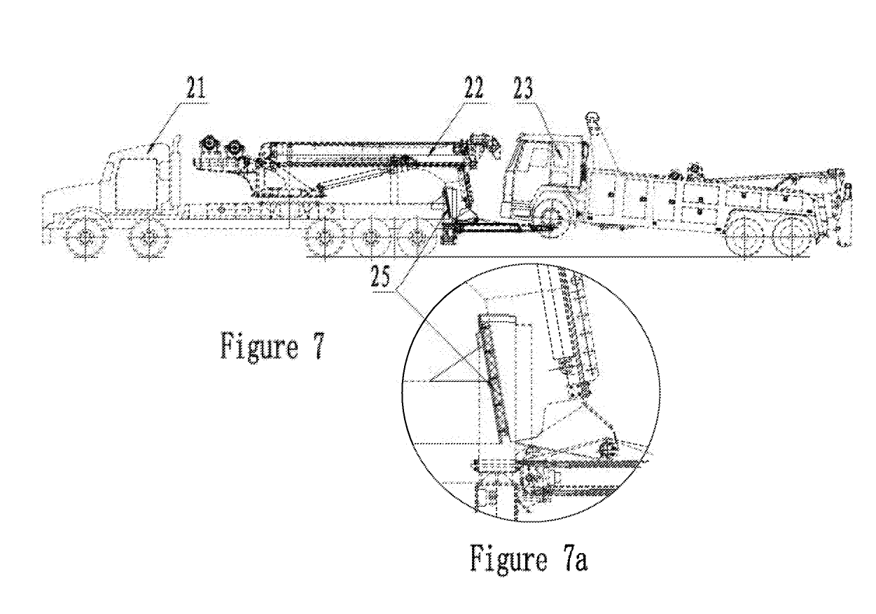

The present invention relocates an underlift/vertical arm assembly from the end of sub-frame to the boom of a wrecker, and that leaves a large space to construct a special structure for protecting a vertical arm from damage. Each part of 1, 18, 19, 24, 26 and 27 shown in FIG. 5 is at the right niche to support a nylatron pad 25 that contacts a vertical arm and holds it at the original position. All these parts constitute a structural integrity by welding a large steel plate 24 with two outer vertical barrels 1, a triangle support 26, a strong bean 19 and sub-frame 27 in which the sub-frame is also welded with the chassis frame 18 for further increasing rigidity of the whole structure. A nylaton pad 25 is fixed on a steel plate 24 which is welded with two outer vertical barrels 1, and that results in placing a nylatron pad between two outer vertical barrels as shown in FIG. 6. Such a structural integrity is so strong that it holds a vertical arm at that position while a wrecker 21 loaded with a wrecked car 23 (FIG. 7) suddenly reduces its speed due to an unexpected situation.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A rear outrigger device designed by using whole space of an end of a sub-frame as an underlift/vertical arm assembly which is relocated from the end of the sub-frame to a boom of a wrecker, the rear outrigger device comprising:
an outer horizontal barrel;
two rear inner vertical barrels, wherein the two rear inner vertical barrels are symmetrically fastened on the outer horizontal barrel; and
two outer vertical barrels, wherein the two outer vertical barrels are fixed onto the subframe and are integrated all together via one horizontal bar,
wherein the two rear inner vertical barrels are connected to the two outer vertical barrels, respectively, via a first hydraulic cylinder and a first hinge pin;
wherein a primary inner sleeve and a secondary inner sleeve are equipped internally at each end of an outer horizontal barrel, and the primary inner sleeve and the secondary inner sleeve are interlinked with a second hinge pin via a second hydraulic cylinder inside the outer horizontal barrel; and
wherein a first diagonal lever is symmetrically fixed to a position between a top end of two rear inner vertical barrels and the outer horizontal barrel, and a second diagonal lever is symmetrically fixed to a position between a top end of two outer vertical barrels and the two primary inner sleeves.

2. The rear outrigger device of claim 1, wherein
two steel rings are installed at each external wall of the two outer vertical barrels, and one end of the second diagonal lever is connected with at least one of the two steel rings and an opposite end of the second diagonal lever is linked to the external wall of the primary inner sleeve via a third hinge pin.

3. A system for at least one of a street wrecker, a derrick car and a elevating platform vehicle, wherein the rear outrigger device of claim 1 is applied to the front outrigger the at least one of a street wrecker, a derrick car and a elevating platform vehicle.

4. A system for a vehicle, wherein the rear outrigger device of claim 1 is applied to the front outrigger of the vehicle.
